(19) United States
(12) Patent Application Publication
(10) Pub. No.: US 2020/0198363 A1
(43) Pub. Date: Jun. 25, 2020

(54) IMAGE FORMING APPARATUS, HALFTONE PROCESSING METHOD, AND HALFTONE PROCESSING PROGRAM

(71) Applicant: KONICA MINOLTA, INC., Tokyo (JP)

(72) Inventors: Makoto HORI, Tokyo (JP); Toshiyuki MIZUTANI, Tokyo (JP)

(73) Assignee: KONICA MINOLTA, INC., Tokyo (JP)

(21) Appl. No.: 16/703,197

(22) Filed: Dec. 4, 2019

(30) Foreign Application Priority Data
Dec. 21, 2018 (JP) 2018-239681

(51) Int. Cl. B41J 2/205; B41J 2/21; B41J 29/393; H04N 1/405

(52) U.S. Cl. CPC B41J 2/2054; B41J 2/2056; B41J 2/2135; B41J 2202/20; B41J 29/393; H04N 1/405; B41J 2202/15; B41J 2/2121

(57) ABSTRACT

An image forming apparatus includes: a nozzle head in which nozzles that form dots on a recording medium by ejecting ink onto the recording medium are arranged in a row in a first direction; a moving mechanism that moves at least one of the recording medium or the nozzle head relative to another in a second direction intersecting the first direction; an image acquirer that acquires image data for forming an image of dots on the recording medium; and a halftone processor that determines whether to form a dot at each pixel position of the image on the basis of the image data, wherein the halftone processor includes: an n-value processor; a grouping processor; a total value calculator; and a rearrangement processor.

The entire disclosure of Japanese patent Application No. 2018-239681, filed on Dec. 21, 2018, is incorporated herein by reference in its entirety.

### BACKGROUND

### Technological Field

The present invention relates to an image forming apparatus, a halftone processing method, and a halftone processing program.

### Description of the Related Art

In inkjet image forming apparatuses, a nozzle head is used in general in which a plurality of nozzle rows, in which a plurality of nozzles is arranged in a row, is formed in alignment in a nozzle row direction intersecting a paper conveyance direction in such a manner that the nozzle rows are parallel to each other. In such a nozzle head, the nozzles are staggered so as not to overlap each other when viewed from the paper conveyance direction in order to increase the recording density of dots formed on a recording medium such as a sheet of paper by ink ejected from each of the nozzles.

For example in a case where a first nozzle row and a second nozzle row are arranged side by side in a nozzle head in the nozzle row direction, each nozzle of the second nozzle row is arranged in the middle of adjacent nozzles of the first nozzle row. With the first nozzle row and the second nozzle row formed in this manner, the pitch of dots formed on the sheet of paper by the ink ejected from the nozzles of the first nozzle row and the second nozzle row becomes half of the nozzle interval of the first nozzle row and the second nozzle row. Therefore, the density of dots formed on a sheet of paper can be increased.

However, in a case where such a nozzle head is installed while tilted for some reason, the pitch of dots formed on a sheet of paper becomes not constant, and image defects such as gloss streaks and unevenness may occur.

With regard to this, JP 2008-155382 A describes technology for reducing gloss streaks and unevenness caused by a tilted nozzle head by using a sub nozzle in addition to the main nozzle and hitting correction dots in addition to the main dots.

However, the technology disclosed in JP 2008-155382 A has disadvantages that the size of the nozzle head increases and that the cost also increases.

### SUMMARY

The present invention has been devised in view of the above disadvantages. Therefore, an object of the present invention is to provide an image forming apparatus, a halftone processing method, and a halftone processing program that prevent or mitigate image defects due to a tilted nozzle head while an increase in the size or the cost of the nozzle head is avoided.

To achieve the abovementioned object, according to an aspect of the present invention, an image forming apparatus reflecting one aspect of the present invention comprises: a nozzle head in which nozzles that form dots on a recording medium by ejecting ink onto the recording medium are arranged in a row in a first direction; a moving mechanism that moves at least one of the recording medium or the nozzle head relative to another in a second direction intersecting the first direction; an image acquirer that acquires image data for forming an image of dots on the recording medium; and a halftone processor that determines whether to form a dot at each pixel position of the image on the basis of the image data, wherein the halftone processor comprises: an n-value processor that performs n-value processing on the image data to generate n-value data; a grouping processor that groups a plurality of pixel positions adjacent in the second direction into one group in the n-value data; a total value calculator that calculates a total value of n-value data at respective pixel positions of each of the group; and a rearrangement processor that performs, on the basis of the total value, rearrangement processing of rearranging density of dots at respective pixel positions of the image data so as to suppress continuous formation of dots on the recording medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a block diagram illustrating an exemplary schematic configuration of an image forming apparatus according to an embodiment;

FIG. 2A is a schematic diagram for explaining a schematic structure of a nozzle head of an image former illustrated in FIG. 1;

FIG. 2B is a schematic diagram for explaining dots formed on a sheet of paper by ink ejected from the nozzle head;

FIG. 3 is a block diagram illustrating an exemplary schematic configuration of an image processor illustrated in FIG. 1;

FIG. 4 is a schematic diagram illustrating an example of a threshold matrix;

FIG. 5 is a block diagram illustrating an exemplary schematic configuration of a halftone processor illustrated in FIG. 3;

FIG. 6 is an explanatory diagram in which a flowchart illustrating an exemplary schematic flow of halftone processing is associated with schematic diagrams of results of respective steps of processing;

FIG. 7 is a schematic diagram illustrating an example of a rearrangement pattern;

FIG. 8 is a subroutine flowchart for explaining in detail rearrangement processing in a case where a threshold matrix is used without using a rearrangement pattern;

FIG. 9 is a schematic diagram for explaining a case where dots are formed with the nozzle head tilted;

FIG. 10 is a schematic diagram for explaining the positions of dots formed on a sheet of paper in a case where the dots are formed with the nozzle head tilted;

FIG. 11 is a scanned image illustrating results of dot formation in a state where the nozzle head is tilted and in a state where the nozzle head is not tilted in an example;

FIG. 12 is a graph illustrating fluctuations in the density with respect to the inclination of the nozzle head in the example;

FIG. 13 is a scanned image illustrating results of dot formation in a state where the nozzle head is tilted and in a state where the nozzle head is not tilted in a comparative example; and

FIG. 14 is a graph illustrating fluctuations in the density with respect to the inclination of the nozzle head in the comparative example.

### DETAILED DESCRIPTION OF EMBODIMENTS

Hereinafter, one or more embodiments of the present invention will be described with reference to the drawings. However, the scope of the invention is not limited to the disclosed embodiments.

### Embodiment

<Configuration of Image Forming Apparatus 100>

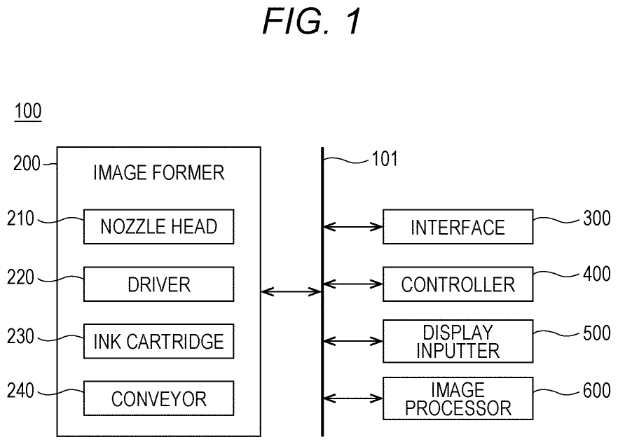

FIG. 1 is a block diagram illustrating an exemplary schematic configuration of an image forming apparatus 100 according to an embodiment. As illustrated in FIG. 1, the image forming apparatus 100 includes an image former 200, an interface 300, a controller 400, a display inputter 500, and an image processor 600. These components are connected by an internal bus 101 in a mutually communicable manner.

The image former 200 includes a nozzle head 210, a driver 220, an ink cartridge 230, and a conveyor 240.

The nozzle head 210 includes a plurality of nozzles that form dots on a sheet of paper (recording medium) by ejecting ink onto the sheet of paper. Details of the nozzle head 210 will be described later.

The driver 220 drives the nozzle head 210 in accordance with instructions from the controller 400. The ink cartridge 230 contains ink to be ejected from the nozzles of the nozzle head 210. The conveyor 240 operates as a moving mechanism and moves a sheet of paper in parallel with respect to the nozzle head 210 by conveying the sheet of paper in a predetermined paper conveyance direction.

Although illustration is omitted, the image forming apparatus 100 is an ink jet printer capable of forming an image using inks of a plurality of colors, and the image former 200 includes a nozzle head 210, a driver 220, and an ink cartridge 230, and other components for each of the plurality of colors.

<Configuration of Nozzle Head 210>

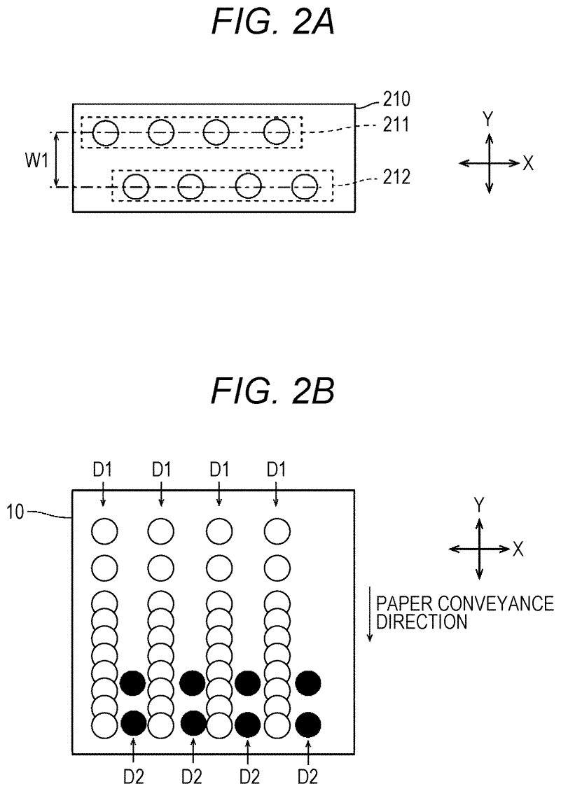

FIG. 2A is a schematic diagram for explaining a schematic structure of the nozzle head 210 of the image former 200 illustrated in FIG. 1, and FIG. 2B is a schematic diagram for explaining dots formed on a sheet of paper by ink ejected from the nozzle head 210. In the example illustrated in FIGS. 2A and 2B, an X direction (first direction) and a Y direction (second direction) intersecting the X direction coincide with the sheet width direction and the sheet conveyance direction, respectively.

As illustrated in FIG. 2A, the nozzle head 210 includes a plurality of nozzles (for example, nozzle rows 211 and 212). The plurality of nozzles is provided, for example, in a row along an X direction, and forms dot rows on a sheet of paper by ejecting ink onto the sheet of paper. The nozzle density in the X direction of the nozzle rows 211 and 212 may be, for example, 600 dots per inch (DPI). The distance between the nozzle row 211 and the nozzle row 212 is W1.

The nozzle rows 211 and 212 are arranged substantially in parallel to each other and staggered in the X direction, that is, shifted by half the nozzle pitch so that the positions of the nozzles of the nozzle rows do not overlap each other when viewed from the Y direction.

By arranging the nozzle rows 211 and 212 in this manner, as illustrated in FIG. 2B, dot rows D2 by the nozzle row 212 are formed in the middle of dot rows D1 by the nozzle row 211. As a result, the dot density becomes higher in the X direction than the nozzle density of the nozzle rows 211 and 212, thereby allowing the resolution of an image formed on a sheet of paper 10 to be increased. Note that the nozzle head 210 is provided with an adjustment mechanism that adjusts the direction of arrangement of the nozzles of the nozzle rows 211 and 212, and is capable of adjusting to a direction desired by a user in the Y direction.

The nozzle row 212 is positioned downstream from the nozzle row 211 by W1 in the Y direction. For this reason, the controller 400 controls and causes the driver 220 to perform ejection of ink by the nozzle row 212 at timing delayed by time T1, which is time for the sheet of paper 10 to be conveyed by W1, from the ejection timing of ink by the nozzle row 211. As a result, dot rows D1 are formed in the Y direction in advance by the nozzle row 211, and after T1 has passed, dot rows D2 are formed by the nozzle row 212 between the dot rows D1. This allows the positions where formation of the dot rows D1 and the dot rows D2 starts to be aligned.

In this manner, the plurality of nozzle rows is arranged in the Y direction, and the nozzles are arranged so as not to overlap each other in the Y direction. This can further save the space and implement printing with high resolution.

Since there are two nozzle rows in this embodiment, the dot density is doubled, that is, a dot density of 1200 DPI is obtained. In a case where two nozzle rows are lines like the nozzle rows 211 and 212, it is desirable that the dot rows D1 and D2 in the Y direction formed by the respective nozzles of the nozzle rows 211 and 212 be adjacent to each other.

The ink ejected from the nozzle rows 211 and 212 adheres to the sheet of paper 10 in the form of droplets and is fixed. As a result, the dot rows D1 and D2 are formed on the sheet of paper 10. Note that using a gel UV ink can reduce positional deviation when the dot rows D1 and D2 are formed on the sheet of paper 10.

The interface 300 performs data transmission with an external device. The interface 300 includes a communication device such as a network interface card (NIC) and performs data transmission with an external device through a line. Data transmission by the interface 300 may be performed regardless of whether in a wired or wireless manner, and regardless of protocols or conditions (for example, standards) regarding other connection formats.

The controller 400 is a computer including a central processing unit (CPU), a random access memory (RAM), a read only memory (ROM), and an auxiliary storage (not illustrated). The controller 400 controls the operation of the image forming apparatus 100 by software processing. The auxiliary storage includes, for example, a hard disk drive (HDD), a solid state drive (SSD), and a flash memory.

The CPU executes a program developed in the RAM to control the operation of the image forming apparatus 100. A program is stored in advance in the ROM or the auxiliary storage. The RAM stores data developed by CPU processing, data temporarily generated by the processing, and the like. The ROM stores programs to be executed by the CPU, data, and the like.

The display inputter 500 has an inputter and an outputter. The inputter includes, for example, a keyboard and/or a touch panel, and is used for a user to perform various instructions (input) such as inputting characters, various settings, and a print instruction. The outputter includes a display, and is used to present the device configuration, print settings, an execution status of a print job, and the like to the user by displaying (outputting) them on the display.

<Configuration of Image Processor 600>

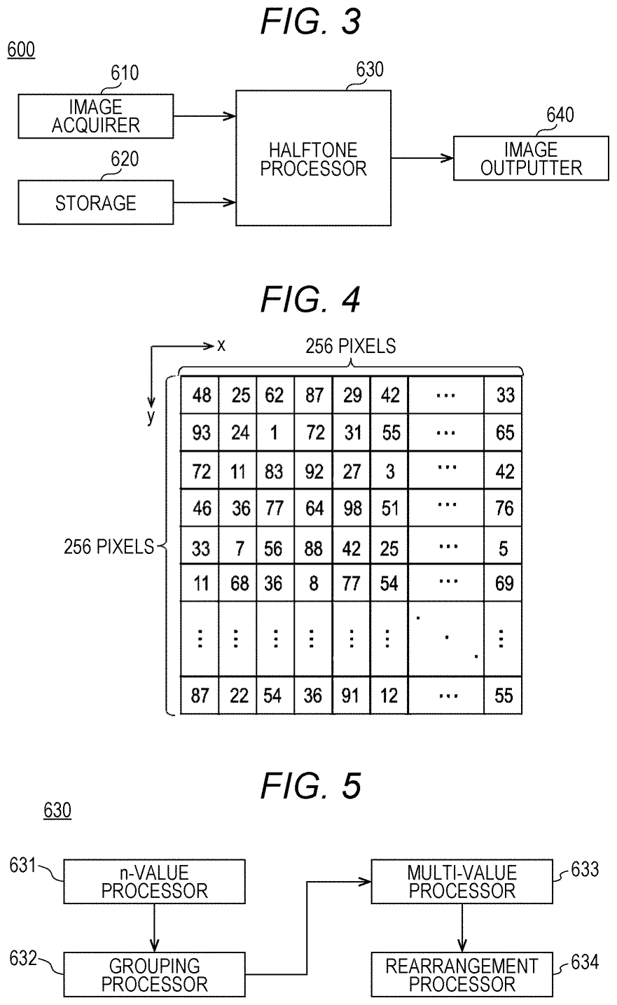

FIG. 3 is a block diagram illustrating an exemplary schematic configuration of the image processor 600 illustrated in FIG. 1, and FIG. 4 is a schematic diagram illustrating an example of a threshold matrix. FIG. 5 is a block diagram illustrating an exemplary schematic configuration of a halftone processor illustrated in FIG. 3.

The image processor 600 performs halftone processing on image data that is the original data of a dot image formed on the sheet of paper 10 by the image former 200. The image processor 600 includes an image acquirer 610, a storage 620, a halftone processor 630, and an image outputter 640.

The image acquirer 610 acquires image data to be subjected to halftone processing and inputs the image data to the halftone processor 630. The image acquirer 610 acquires, for example, image data input from an external device via the interface 300, image data having been subjected to image processing by the controller 400, and the like.

The storage 620 is a storage device that stores a threshold matrix for performing n-value processing, and includes a storage device such as a flash memory. As illustrated in FIG. 4, the threshold matrix of the present embodiment is data in which a threshold value is set for respective pixels that correspond to a predetermined pixel region.

The predetermined pixel region is, for example, a pixel region of 256×256 [pixels] along an x direction along a line of pixels forming image data and along a y direction orthogonal to the x direction. For each of the pixels of the threshold matrix, a threshold value corresponding to n-value processing, to be described later, is set. A threshold value of each of the pixels is for determining whether to perform dot formation for each pixel in a pixel region corresponding to a predetermined pixel region among the pixel regions that form the image data, and (n−1) values are set. For example in the case of binarization, one threshold value is set.

Although the threshold matrix used in the present embodiment has 256×256 [pixels] as illustrated in FIG. 4, the number of threshold values included in the threshold matrix, that is, the number, and arrangement, of pixels in the pixel region corresponding to the threshold matrix may be set as desired. For example, the size of the threshold matrix may be set so as to cover the entire image data.

A plurality of pixels forming a part or all of image data, that is, a plurality of pixels arranged along the x direction and the y direction and a plurality of threshold values of the threshold matrix arranged along the x direction and the y direction have a one-to-one relationship. Moreover, each of the pixels of the image data and each dot formed by the plurality of nozzles of the nozzle head 210 have a one-to-one relationship.

The halftone processor 630 may include, for example, an application specific integrated circuit (ASIC) or the like. The halftone processor 630 performs halftone processing (also referred to as quantization processing) on image data on the basis of image data input from the acquirer 610 and the threshold matrix stored in the storage 620.

The halftone processing is performed on all the pixels of the image data with the size of a predetermined pixel region of the threshold matrix used as one unit. For example in a case where the pixel region of the image data is larger than a predetermined pixel region (for example, 256×256 [pixels]), an image region of the image data is divided into predetermined units of pixel regions, and halftone processing is performed on each of the divided pixel regions.

As illustrated in FIG. 5, the halftone processor 630 includes an n-value processor 631, a grouping processor 632, a multi-value processor (total value calculator) 633, and a rearrangement processor 634. The n-value processor 631 performs n-value processing on the image data acquired by the image acquirer 610 to generate n-value conversion data. Details of the n-value processing will be described later.

The grouping processor 632 groups a plurality of pixel positions adjacent in the Y direction into one group in the n-value conversion data generated by the n-value processor 631. Details of the grouping processing will be described later.

The multi-value processor 633 performs multi-value processing in which the total value of n-value data of respective pixel positions is calculated for each group. Details of the multi-value processing will be described later.

The rearrangement processor 634 rearranges the density of dots at each pixel position of the image data on the basis of the total value so as to suppress continuous formation of dots. Details of the rearrangement processing will be described later.

The image outputter 640 outputs the image data that has been subjected to the halftone processing by the halftone processor 630.

<Halftone Processing Method>

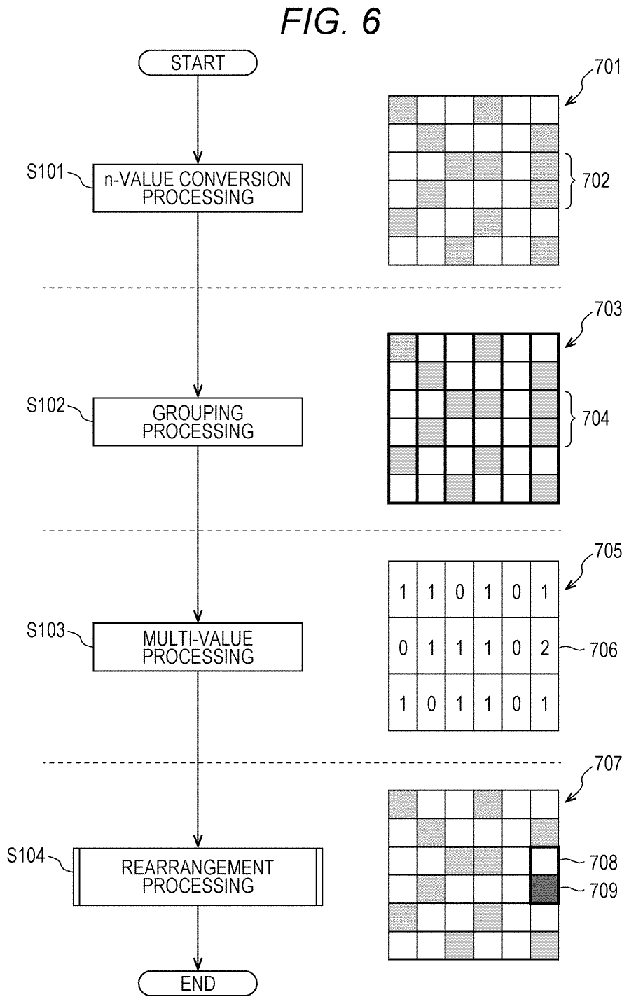

FIG. 6 is an explanatory diagram in which a flowchart illustrating an exemplary schematic flow of the halftone processing is associated with schematic diagrams of results of the respective steps of processing.

First, the n-value processor 631 performs n-value processing (step S101). The n-value processing is to convert the value of each pixel of image data (for example, 0 to 256) into n-stage values using a threshold value. Here, n is a natural number greater than or equal to 2.

More specifically, when image data is input from the image acquirer 610, the n-value processor 631 reads a threshold matrix from the storage 620. Subsequently, the n-value processor 631 compares a pixel value of each pixel in the range of a predetermined pixel region (for example, 256×256 [pixels]) in the pixel region of the image data to a threshold value of the pixels set in the threshold matrix to convert the pixel value into an n-stage value.

For example, in a case where n=2 and the threshold value is 128, each pixel of the image data is compared with the threshold value of 128, and each pixel value is converted into one of two stages of “1” or “0” depending on the magnitude relationship with the threshold value of 128. Each of the pixel values “1” and “0” corresponds to whether to form or not to form a dot for each of the pixels in the predetermined pixel region. The n-value processor 631 outputs the binarized image data as binarized data (n-value data).

Note that FIG. 6 illustrates, as an example, a pattern 701 partially illustrating binarized data obtained by binarizing the image data. In the pattern 701, the pixel value of “1” corresponds to a gray portion, and “0” corresponds to a white portion.

In the pattern 701, a portion where the pixel value “1” is continuous in the Y direction (for example, continuous pixels 702) means that dots are expected to be formed continuously at this point. As will be described below, continuous formation of dots is suppressed in this embodiment by reducing the portion where the pixel value “1” is continuous through the grouping processing, the multi-value processing, and the rearrangement processing.

Next, the grouping processor 632 performs grouping processing (step S102). The grouping processor 632 performs grouping processing for grouping a plurality of pixel positions adjacent along the Y direction to form one group of pixels. Here, the grouped pixels of one group are, for example, a group of a plurality of pixels corresponding to a plurality of dots adjacent along the Y direction of the dot rows D1 and D2 on the sheet of paper 10 illustrated in FIG. 2B.

FIG. 6 illustrates a pattern 703 partially illustrating data obtained by grouping two pixels adjacent along the Y direction as one group. Two adjacent pixels encircled by a bold line form one group. Note that three or more pixels adjacent in the Y direction can form one group.

Next, the multi-value processor 633 performs multi-value processing (step S103). The multi-value processor 633 performs multi-value processing for performing multi-value conversion on pixels of each group having been grouped in step S102 with a value larger than n.

For example in a case where n=2, the multi-value processor 633 calculates a total value of a plurality of pixel values (“1” or “0”) included in each group. For example in the multi-value processing after the grouping processing of grouping two pixels into one group of pixels has been performed as in the example illustrated in FIG. 6, in a case where both of two pixels in one group are “1”, the total value is “2”, and in a case where one of two pixels is “1” and the other is “0”, the total value is “1”. In a case where two pixels in one group of pixels are both “0”, the total value is “0”. In this manner, the multi-value processor 633 calculates the total value of n-value data at respective pixel positions in each group. The total value corresponds to a total ejection amount M of the pixels in the group.

In FIG. 6, a pattern 705 illustrating the total value of each group is illustrated as an example. The pattern 705 includes a plurality of elements corresponding to the respective groups of the pattern 703. Where n=2, the total value of each group ranges from 0 to 2. For example, a group 704 in the pattern 703 has a total value of 2, obtained from 1+1 since the two pixels are both “1”. Therefore, the value of an element 706 corresponding to the group 704 is “2”.

Next, the rearrangement processor 634 performs rearrangement processing (step S104). The rearrangement processor 634 determines the arrangement of dots on the basis of a rearrangement pattern, which will be described later, or the threshold matrix. The rearrangement processor 634 determines the density of dots on the basis of the total value of each group.

The rearrangement processor 634 performs processing of assigning dots having a density corresponding to the total value of each group to pixels less than the number of pixels included in each group. That is, the rearrangement processor 634 performs processing of assigning ink ejection corresponding to the total value (corresponding to the total ejection amount M) of each group determined in the multi-value processing to the pixels less than (N−1) pixels out of all the (N) pixels included in a group. For example in the case where N=2, a dot is assigned to one of the two pixels in a group.

In FIG. 6, a pattern 707 illustrating a part of pixel values after the rearrangement processing is illustrated as an example. By the rearrangement processing, a total value of 2 of the group 704 is assigned to a pixel 709 out of the pixels 708 and 709 of the pattern 707, and the value of the pixel 708 has become 0. The specific processing method of the rearrangement processing is as follows.

<Rearrangement Processing>

The rearrangement processing can be performed by (I) a method using a rearrangement pattern and a threshold matrix, or (II) a method using a threshold matrix without using a rearrangement pattern.

(I) Method Using Rearrangement Pattern and Threshold Matrix

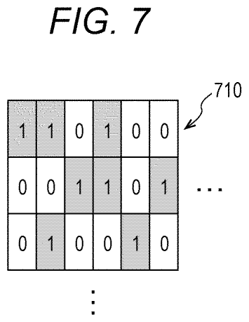

FIG. 7 is a schematic diagram illustrating an example of a rearrangement pattern. A rearrangement pattern 710 indicates whether to replace pixel values for each group. A value “1” indicates that replacement is performed, and “0” indicates that no replacement is performed. The rearrangement pattern 710 of this embodiment has high resolution in the nozzle arrangement direction (X direction) of the nozzle rows 211 and 212. This facilitates dots to be merged in the Y direction. Note that a part of the whole rearrangement pattern of 256×128 pixels is illustrated in FIG. 7.

The rearrangement processor 634 applies the rearrangement pattern 710 to the total value of each group to determine whether to replace pixel values for each group having been grouped by the above-described grouping processing.

More specifically, for each group, the rearrangement processor 634 determines that replacement of pixel values is necessary in a case where the total value of the group is “2” and a corresponding value of the rearrangement pattern 710 is “1”. On the other hand, in a case where the total value of a group is other than “2”, that is, “0” or “1”, or in a case where the value of the rearrangement pattern 710 is “0”, the pixel values are not replaced.

For example, since the element 706 of the pattern 705 illustrated in FIG. 6 has a value of “2” and the corresponding value of the rearrangement pattern 710 is “1”, the rearrangement processor 634 determines that replacement of pixel values is necessary. Meanwhile, since the values of the elements other than the element 706 are either “0” or “1” in the pattern 705, the pixel values in the groups are not replaced.

The rearrangement processor 634 replaces pixel values of a group determined as being in need of replacement on the basis of Table 1 below. Note that the pixel values (odd-numbered pixel and even-numbered pixel) before rearrangement processing in Table 1 refer to pixel values of the odd-numbered pixel and the even-numbered pixel in the group, respectively. Where N=2, the odd-numbered pixel is the first pixel, and the even-numbered pixel is the second pixel.

TABLE 1

| Pixel value before | Pixel value before | Pixel value after | Pixel value after |
|---|---|---|---|
| rearrangement processing | rearrangement processing | rearrangement processing | rearrangement processing |
| (odd-numbered pixel) | (even-numbered pixel) | (odd-numbered pixel) | (even-numbered pixel) |
| 0 | 0 | 0 | 0 |
| 0 | 1 | 0 | 1 |
| 1 | 0 | 1 | 0 |
| 1 | 1 | 0 | 2 |

The rearrangement processor 634 replaces (rearranges) “1” of the odd-numbered pixel and “1” of the even-numbered pixel of the group 704 with “0” for the odd-numbered pixel and “2” for the even-numbered pixel, respectively (pixel values after the rearrangement processing).

Furthermore, in a case where the value of the rearrangement pattern 710 is “1”, instead of the replacement processing illustrated in Table 1 above, whether to form a dot may be determined on the basis of the magnitude relationship with a threshold value of a threshold matrix corresponding to each pixel in one group. For example, in a case where two pixels are included in one group of pixels, the total value of the group is assigned to a pixel having a larger threshold value in the threshold matrix, and the other pixel is set to 0.

The image former 200 forms an image according to the arrangement and density values of the dots rearranged by the halftone processing based on the pixel values after the rearrangement processing.

As described above, the present embodiment enables reduction of continuous pixel values of “1” in the Y direction by, in the halftone processing, grouping pixels adjacent in the Y direction into one group when the grouping processing is performed after the multi-value processing is performed and by performing replacement on the basis of the rearrangement pattern 710. Therefore, it is possible to suppress continuous formation of dots on the sheet of paper 10 with the same nozzles, and thus it is possible to reduce the occurrence of image defects such as gloss streaks and unevenness while an increase in the size or the cost of the nozzle head is avoided.

(II) Method Using Threshold Matrix without Using Rearrangement Pattern

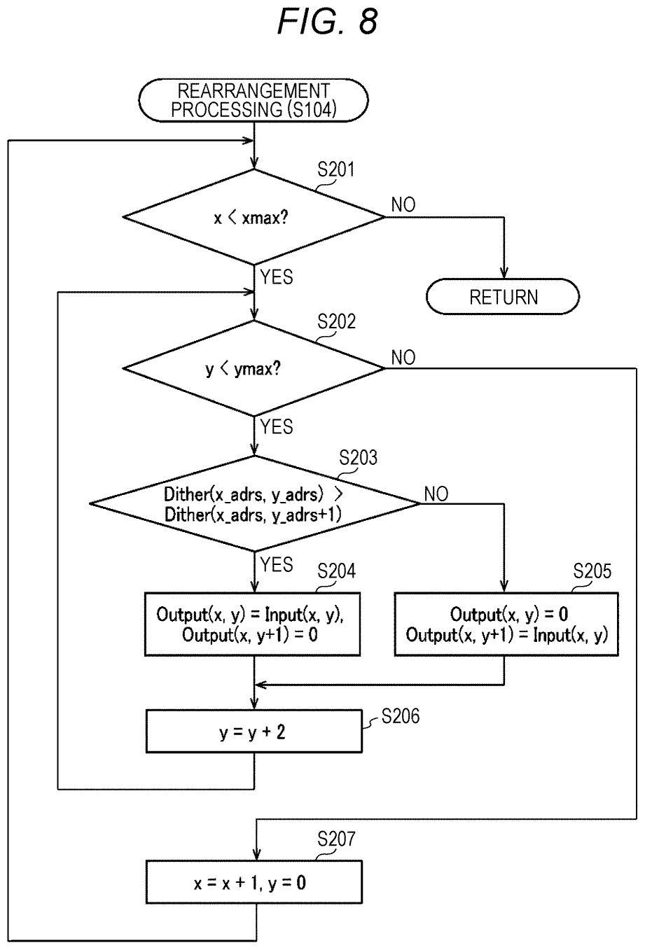

Next, with reference to FIG. 8, an outline of the processing procedure of rearrangement processing in a case where a threshold matrix is used without using a rearrangement pattern will be described. FIG. 8 is a subroutine flowchart for explaining in detail rearrangement processing in a case where a threshold matrix is used without using a rearrangement pattern. The subroutine flowchart of FIG. 8 exemplifies the case where step S101 of FIG. 6 is binarization processing and two pixels formed of one pixel in the X direction and two pixels in the Y direction are grouped into one group in step S102. Note that a pixel region to be processed is denoted by (x, y). The initial values of x and y at the start of the rearrangement processing are both 0.

Meanwhile, the number of pixels in the X direction of a predetermined pixel region of the threshold matrix is denoted by xmax, and the number of pixels in the Y direction is denoted by ymax.

First, the rearrangement processor 634 checks whether (x, y) is within a predetermined region. Specifically, the rearrangement processor 634 determines whether x is smaller than xmax (step S201). If x is smaller than xmax (step S201: YES), the rearrangement processor 634 determines whether y is smaller than ymax (step S202).

Note that values (x, y) in the predetermined pixel region may range from (0, 0) to (xmax−1, ymax−1).

If y is smaller than ymax in step S202 (step S202: YES), the rearrangement processor 634 determines whether the following inequality (1) is satisfied (step S203).

Dither(x_adrs,y_adrs)>Dither(x_adrs,y_adrs+1) (1)

Inequality (1) is satisfied when a threshold value of the threshold matrix referenced by Dither (x_adrs, y_adrs) is larger than a threshold value referenced by Dither (x_adrs, y_adrs+1).

In inequality (1), Dither (a, b) represents a threshold value set at coordinates (a, b) in a predetermined pixel region of the threshold matrix. In this example, numerical values of both a and b may range from 0 to 255. Meanwhile, x_adrs indicates a remainder when x is divided by 256, and y_adrs indicates a remainder when y is divided by 256, and these can be applied to any x and y so as not to exceed the coordinate region of the threshold value region. That is, x_adrs and y_adrs each indicate an address value for referring to the threshold matrix. Note that y_adrs+1 is a value obtained by adding 1 to a remainder obtained by dividing y by 256. When the variable of y changes as in step S206 which will be described later, the value of y_adrs changes as 0, 2, 4, . . . , 254. Therefore, even with y_adrs+1, the coordinate region of the threshold value region from 0 to 255 is not exceeded.

If inequality (1) is satisfied (step S203: YES), the rearrangement processor 634 sets the total value of the group including (x, y) to the dot value of (x, y), and sets 0 to the dot value of (x, y+1) (step S204). On the other hand, if inequality (1) is not satisfied (step S203: NO), the rearrangement processor 634 sets 0 to the dot value of (x, y) and sets the total value of the group including (x, y) to the dot value of (x, y+1) (step S205). After the processing of step S204 or the processing of step S205, the rearrangement processor 634 adds 2 to the value of y (step S206), and returns to the processing of step S202. In the subroutine flowchart of FIG. 8, a dot value of (x, y) is represented as Output (x, y), a dot value of (x, y+1) is represented as Output (x, y+1), and the total value of a group including (x, y) is represented as Input (x, y).

If y is larger than ymax in step S202 (step S202: NO), the rearrangement processor 634 adds 1 to the value of x and sets the value of y to 0 (step S207), and then returns to the processing of step S201.

If x is larger than xmax in step S201 (step S201: NO), the rearrangement processor 634 ends the rearrangement processing. When the rearrangement processing ends, the halftone processing ends.

In the processing illustrated in the flowchart in FIG. 6 described above, the halftone processor 630 performs the n-value processing, the grouping processing, the multi-value processing, and the rearrangement processing. In the n-value processing, the n-value processing is performed on image data to generate n-value data. In the grouping processing, the halftone processor 630 performs, on the n-value data, grouping processing of grouping a plurality of pixel positions adjacent in the Y direction into one group. In the multi-value processing, the halftone processor 630 performs multi-value processing of calculating the total value of each group. Furthermore, in the rearrangement processing, the halftone processor 630 rearranges the density of dots at each pixel position of the image data so as to suppress continuous formation of dots on the basis of the total value of the group.

Fluctuations in Density with Respect to Inclination of Nozzle Head 210

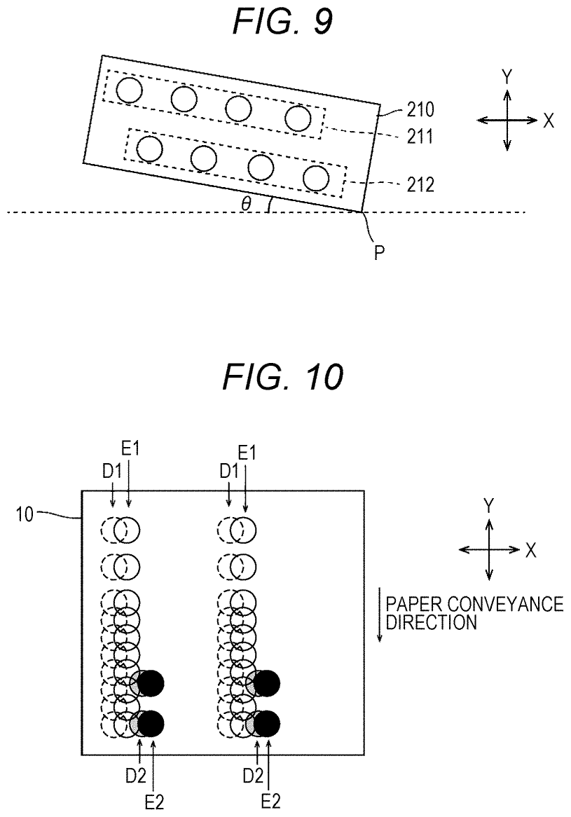

FIG. 9 is a schematic diagram for explaining a case where dots are formed with the nozzle head 210 tilted, and FIG. 10 is a schematic diagram for explaining the positions of dots formed on the sheet of paper 10 in a case where the dots are formed with the nozzle head 210 tilted.

A case where dots are formed with the nozzle head 210 tilted by an angle θ with respect to the X direction (see FIG. 9) will be described in comparison with a case where dots are formed with the nozzle head 210 not tilted.

As illustrated in FIG. 10, in a case where dots are formed with the nozzle head 210 not tilted with respect to the X direction, dot rows formed by the nozzle rows 211 and 212 are formed at positions indicated by D1 and D2, respectively. On the other hand, in a case where dots are formed with the nozzle head 210 is tilted by the angle θ with respect to the X direction, dot rows formed by the nozzle rows 211 and 212 are formed at positions indicated by E1 and E2, respectively.

As illustrated in FIG. 9, in a case where the nozzle head 210 is tilted by the angle θ with respect to the X direction, the nozzle rows 211 and 212 are considered to have rotated by 0 with respect to the horizontal direction with a point P of the nozzle head 210 being as the center of rotation. Since the nozzle row 211 is farther from the center of rotation than the nozzle row 212 is, the distance of movement of the nozzles in the X direction before and after the rotation of the nozzle head 210 is longer for the nozzle row 211 than for the nozzle row 212. As a result, the distance between the dot row E1 and the dot row E2 is smaller than the distance between the dot row D1 and the dot row D2. Therefore, there is a shift in the X direction in the positions of the dot rows formed on the sheet of paper 10 depending on whether the nozzle head 210 is not tilted or tilted.

Meanwhile, in the present embodiment, a plurality of pixels adjacent in the Y direction is grouped as one group in the image data after the n-value processing in consideration of the positional deviation of dot rows in the X direction. Therefore, it is possible to suppress the influence on the positions where the dot rows are formed.

Therefore, the difference between the dot arrangement obtained by the halftone processing and the dot arrangement actually formed on the sheet of paper 10 is reduced, and the dots can be merged as expected by a user. As a result, a difference in the density difference between adjacent nozzle heads can be suppressed, and the robustness with regard to fluctuations in the density against the inclination of the nozzle head 210 can be improved.

### Example

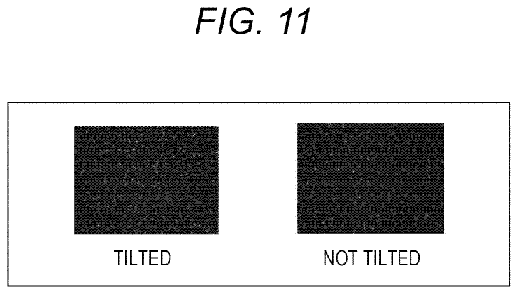

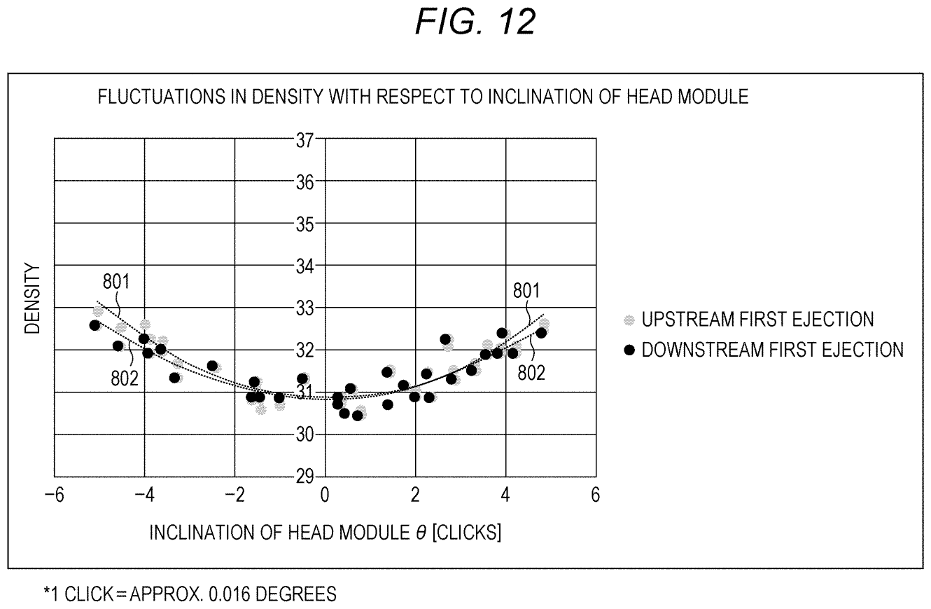

FIG. 11 is a scanned image illustrating results of image formation in a state where the nozzle head 210 is tilted and in a state where the nozzle head 210 is not tilted in an example. FIG. 12 is a graph illustrating fluctuations in the density with respect to the inclination of the nozzle head in the example. In FIG. 12, the horizontal axis represents the inclination of the nozzle head 210, and the vertical axis represents the density. Note that the unit of the horizontal axis is [clicks], and one click corresponds to about 0.016 [degrees].

In this embodiment, images were formed with the nozzle head 210 tilted by the angle θ with respect to the X direction and with the nozzle head 210 not tilted, and the images formed on the sheet of paper were compared.

As illustrated in FIG. 11, there is no significant change in the coverage, which is a ratio of an area covered by dot rows to a surface area, between the case where the nozzle head 210 is tilted and the case where the nozzle head 210 is not tilted.

Meanwhile, as illustrated in FIG. 12, when the inclination of the nozzle head 210 is 0 [clicks], the density has the minimum value of about 31, and when the inclination of the nozzle head 210 is +5 [clicks], the density has the maximum value of about 33. That is, the fluctuation range of the density is approximately 2. Therefore, fluctuations in the density with respect to the inclination of the nozzle head 210 is also suppressed to a small level. Note that “upstream-first ejection” 801 in the graph of FIG. 12 refers to a case where ink is ejected first from the nozzle row 211 (upstream nozzle row), and “downstream-first ejection” 802 refers to a case where ink is ejected first from the nozzle row 212 (downstream nozzle row). Regardless of which of the nozzle rows 211 and 212 first ejects ink, fluctuations in the density with respect to the inclination of the nozzle head 210 is suppressed to a small level.

### Comparative Example

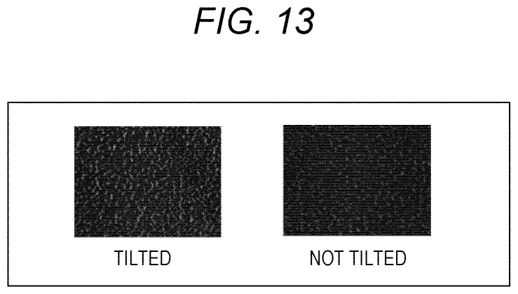

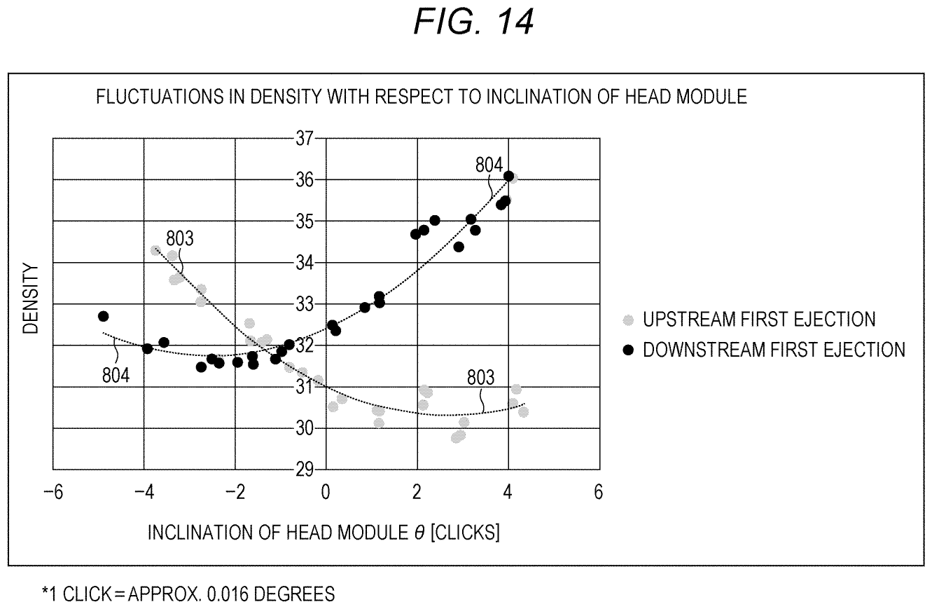

FIG. 13 is a scanned image illustrating results of image formation in a state where the nozzle head 210 is tilted and in a state where the nozzle head 210 is not tilted in a comparative example. FIG. 14 is a graph illustrating fluctuations in the density with respect to the inclination of the nozzle head in the comparative example.

The comparative example has the same configuration as the configuration of the above-described embodiment, except that a plurality of pixels adjacent in the X direction, instead of the Y direction, is grouped as one group in image data after the n-value processing.

As illustrated in FIG. 13, in the state in which the nozzle head 210 is tilted, the coverage is reduced compared to the state in which the nozzle head 210 is not tilted, resulting in portions not covered with dots being conspicuous.

Meanwhile, as illustrated in FIG. 14, when the inclination of the nozzle head 210 is 3 [clicks], the density is about 30 (minimum value) for upstream-first ejection 803, and when the inclination of the nozzle head 210 is about −3 [clicks], the density is about 34 (maximum value), and thus the fluctuation range is approximately 4. Meanwhile, for downstream-first ejection 804, when the inclination of the nozzle head 210 is about −3 [clicks], the density is about 31.5 (minimum value), and when the inclination of the nozzle head 210 is about 4 [clicks], the density is about 36 (maximum value), and thus the fluctuation range is approximately 4.5. Therefore, in the comparative example, fluctuations of the density with respect to the inclination of the nozzle head 210 is significant, and how the density changes with respect to the inclination of the nozzle head 210 differs depending on whether upstream-first ejection or downstream-first ejection.

The present invention is not limited to the above-described embodiments, and various modifications can be made within the scope of the claims.

For example, in the above-described embodiment, the case where the halftone processing is performed by hardware (ASIC) has been described. However, the halftone processing may be performed by a computer executing a halftone processing program.

Moreover, the case where the conveyor 240 conveys the sheet of paper 10 and moves the sheet of paper 10 in the Y direction with respect to the nozzle head 210 has been described in the above-described embodiment; however, the conveyor 240 may move the nozzle head 210 in the −Y direction with respect to the sheet of paper 10. That is, the conveyor 240 moves at least one of the sheet of paper 10 or the nozzle head 210 relative to the other in the Y direction or the −Y direction.

Furthermore, the means and method for performing various types of processing in the image forming apparatus 100 according to the above-described embodiment can be implemented by either a dedicated hardware circuit or a programmed computer. The program may be provided by a computer readable recording medium such as a compact disc read only memory (CD-ROM) or may be provided online via a network such as the Internet. In this case, the program recorded in the computer-readable recording medium is usually transferred to and stored in a storage such as a hard disk. Alternatively, the program may be provided as independent application software or may be incorporated into software of the image forming apparatus 100 as one function thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a nozzle head in which nozzles that form dots on a recording medium by ejecting ink onto the recording medium are arranged in a row in a first direction;
a moving mechanism that moves at least one of the recording medium or the nozzle head relative to another in a second direction intersecting the first direction;
an image acquirer that acquires image data for forming an image of dots on the recording medium; and
a halftone processor that determines whether to form a dot at each pixel position of the image on the basis of the image data,
wherein the halftone processor comprises:
an n-value processor that performs n-value processing on the image data to generate n-value data;
a grouping processor that groups a plurality of pixel positions adjacent in the second direction into one group in the n-value data;
a total value calculator that calculates a total value of n-value data at respective pixel positions of each of the group; and
a rearrangement processor that performs, on the basis of the total value, rearrangement processing of rearranging density of dots at respective pixel positions of the image data so as to suppress continuous formation of dots on the recording medium.

2. The image forming apparatus according to claim 1, wherein the halftone processor further comprises a storage that stores a rearrangement pattern indicating a pixel position where the rearrangement processing is to be performed, and
the rearrangement processor rearranges the density of dots on the basis of the rearrangement pattern.

3. The image forming apparatus according to claim 2, wherein the rearrangement processor rearranges the density of dots on the basis of the rearrangement pattern and a magnitude relationship with a threshold value of a threshold matrix corresponding to each pixel in the one group.

4. The image forming apparatus according to claim 1, wherein multiple rows of nozzles are arranged side by side in the nozzle head.

5. The image forming apparatus according to claim 4, wherein the multiple rows of nozzles are arranged so that positions of the nozzles do not overlap each other when viewed from the second direction.

6. The image forming apparatus according to claim 1, wherein a direction of arrangement of the nozzles is adjustable.

7. The image forming apparatus according to claim 1, wherein the ink adheres to the recording medium in a droplet state and then is fixed.

8. The image forming apparatus according to claim 1, wherein the grouping processor groups two pixel positions adjacent in the second direction into one group in the n-value data.

9. The image forming apparatus according to claim 1, wherein the rearrangement processor rearranges the density of dots at the respective pixel positions of the image data by comparing with a threshold value of a threshold matrix within one group in the second direction.

10. A halftone processing method for an image forming apparatus comprising:
a nozzle head in which multiple nozzles that form dots on a recording medium by ejecting ink onto the recording medium are arranged in a row in a first direction;
a moving mechanism that moves at least one of the recording medium or the nozzle head relative to the other in a second direction intersecting the first direction;
an image acquirer that acquires image data for forming an image of dots on the recording medium; and
a halftone processor that determines whether to form a dot at each pixel position of the image on the basis of the image data,
the halftone processing method comprising:
(a) performing n-value processing on the image data and generating n-value data;
(b) grouping a plurality of pixel positions adjacent in the second direction into one group in the n-value data;
(c) calculating a total value of n-value data at respective pixel positions of each of the group; and
(d) performing, on the basis of the total value, rearrangement processing of rearranging density of dots at respective pixel positions of the image data so as to suppress continuous formation of dots on the recording medium.

11. The halftone processing method according to claim 10, wherein the halftone processor further comprises a storage that stores a rearrangement pattern indicating a pixel position where the rearrangement processing is to be performed, and
the density of dots is rearranged on the basis of the rearrangement pattern in the (d).

12. The halftone processing method according to claim 11, wherein, in the (d), the density of dots is rearranged on the basis of the rearrangement pattern and a magnitude relationship with a threshold value of a threshold matrix corresponding to each pixel in the one group.

13. The halftone processing method according to claim 10, wherein, in the (b), two pixel positions adjacent in the second direction are grouped into one group in the n-value data.

14. The halftone processing method according to claim 10, wherein, in the (d), the density of dots at the respective pixel positions of the image data is rearranged by comparison with a pixel value of a threshold matrix within one group in the second direction.

15. A non-transitory recording medium storing a computer readable halftone processing program causing a computer to execute the halftone processing method according to claim 10.
